(19) United States
(12) Patent Application Publication
(10) Pub. No.: US 2009/0220413 A1
(43) Pub. Date: Sep. 3, 2009

(54) Catalyst For Methane Steam Reformation, Method Of Producing The Same, And Method Of Producing Hydrogen Using The Same

(76) Inventors: Iijima Sumio, Aichi (JP); Masako Yudasaka, Ibaraki (JP); Katsuyuki Murata, Ibaraki (JP)

Correspondence Address: WENDEROTH, LIND & PONACK, L.L.P., 1030 15th Street, N.W.,, Suite 400 East, Washington, DC, 20005-1503, US

(21) Appl. No.: 11/988,027

(22) PCT Filed: Jun. 30, 2006
(86) PCT No.: PCT/JP2006/313073

§ 371 Date: Apr. 1, 2008

(30) Foreign Application Priority Data
Jul. 1, 2005 (JP) 2005-193649

(51) Int. Cl. B01J 21/18; C01B 3/26

(52) U.S. Cl. 423/652; 502/185; 502/184; 977/742; 977/734; 977/962

(57) ABSTRACT

Provided is a novel catalyst for methane steam reformation which enables a highly efficient production of hydrogen at a lower reaction temperature of lower than 500° C. without the need for a high temperature condition of a conventional temperature of 500° C. or higher, actually as high as 700 to 800° C. by use of a catalyst for methane steam reformation that is characterized in supporting one kind or more of noble metals or one kind or more of each of noble metals and lanthanide metals in a microporous carbon material, and a method of producing hydrogen using the catalyst.

### TECHNICAL FIELD

The present invention relates to a novel catalyst useful for producing hydrogen as a fuel for a fuel cell or the like by steam reforming reaction of methane, a method of producing the same, and a method of producing hydrogen by methane steam reformation using the same.

### BACKGROUND ART

Hydrogen as a fuel for a fuel cell must be produced by any method because it cannot be naturally produced. In the present situation, production by steam reformation from methane has been the most important approach. However, since methane reformation shows endothermal reaction, in the present situation, it has been necessary that the production of hydrogen be done while heating at high temperature of 500° C. or higher, more practically roughly 700 to 800° C. Nevertheless, a solid electrolyte fuel cell is operated roughly at 80° C.; therefore, heating at high temperature is a waste of energy and the production of hydrogen is desired to be done at a lower temperature. An efficient approach such as combination with cogeneration or the like is also considered. However, heating at a temperature as high as 700° C. or higher to a fuel cell operating at 80° C. is a waste of energy. Furthermore, the high temperature condition of 700 to 800° C. leads to a drawback of a huge hydrogen-producing apparatus.

In the present situation, various studies on the method of producing hydrogen are in progress. It has been proposed to use, in production of hydrogen or conversion to hydrogen by steam reformation of methane or other hydrocarbons, a noble metal such as Pt (platinum), Pd (palladium), Rd (rhodium) and Ru (ruthenium) or a catalyst in which nickel (Ni) is supported in an oxide support such as alumina, ceria, silica and the like (see, for example, Patent Documents 1 to 3). Additionally, on the other hand, although different from the steam reformation reaction of methane, a method is known that produces hydrogen by decomposition of hydrocarbon by use of a catalyst in which an extremely specific combination of metals such as palladium (Pd) and nickel (Ni) is supported in an oxide support, graphitized carbon fiber support or carbon nanofiber support (Patent Document 4).

However, until now, simple production of hydrogen by a highly efficient steam reformation reaction of methane at lower temperature has not been successful in fact.

In this situation, if a novel technical means for solving the problem is established and the production of hydrogen at lower temperature becomes possible, the miniaturization of an apparatus is also possible and the installation into automobiles becomes possible. Additionally, the installation into a home-use fuel cell system becomes easy.

### Patent Document 1: Japanese Patent Application Laid-Open No. 2002-255508

### Patent Document 2: Japanese Patent Application Laid-Open No. 2003-190742

### Patent Document 3: Japanese Patent Application Laid-Open No. 2003-243018

### Patent Document 4: Japanese Patent Application Laid-Open No. 2004-74061

### DISCLOSURE OF INVENTION

### Problems to be Solved by the Invention

The present invention solves, the conventional problem, and an object of the present invention is to provide a novel catalyst for methane steam reformation that enables a highly efficient production of hydrogen at a lower reaction temperature of lower than 500° C. without the need for a conventional high temperature condition of 500° C. or higher, actually as high as 700 to 800° C., and a method of producing hydrogen using the catalyst.

### Means for Solving the Problems

The present inventors have diligently studied a measure for solving the problem. In the process, the inventors have paid attention to the fact that nanoscale size microporous carbon materials such as a carbon nanotube and carbon nanohorn have an extremely large surface activity, and have searched for a catalyst for methane steam reformation using the microporous carbon material. The attention paid to such nanoscale size microporous carbon material is based on the accumulation of scientific findings by the present inventors who have led the development of nanomaterials such as carbon nanotubes and carbon nanohorns research and development on the applications, and expectation about the possibility.

The present invention was derived from the results of studies by inventors as mentioned above, and makes it possible to produce an excellent catalyst activity that was not expected or predicted at all from the prior art and produce hydrogen at a high efficiency by methane reformation reaction using the catalyst activity.

In other words, the present invention has the following characteristics.

First: A catalyst for methane steam reformation in which one kind or more of noble metals or one kind or more of each of noble metals and lanthanide metals are supported in a microporous carbon material.

Second: The catalyst in which the microporous carbon material is at least either of a carbon nanotube and a carbon nanohorn.

Third: A method of producing the catalyst for methane steam reformation comprising mixing a solution of a compound of a noble metal or of a noble metal and a lanthanide metal and a microporous carbon material, and evaporation-drying or adsorption-supporting.

Fourth: A method of producing the catalyst for methane steam reformation comprising subjecting a microporous carbon material to oxidation treatment or hydrogen treatment in advance and then mixing the resulting microporous carbon material with a solution of a compound of a metal.

Fifth: The method of producing a catalyst for methane steam reformation comprising evaporation-drying or adsorption-supporting, and then water-contact treating at a temperature from 200° C. to 350° C.

Sixth: A method of producing hydrogen by steam reformation reaction of methane comprising producing hydrogen by use of the catalyst by steam reformation reaction of methane.

Seventh: The method of producing hydrogen comprising carrying out steam reformation reaction at a reaction temperature from 200° C. to 700° C.

### EFFECTS OF THE INVENTION

According to a catalyst of the present invention as described above, the catalyst exhibits high reactivity in the temperature range of 200° C. or higher, more preferably 350° C. to 500° C. and achieves high hydrogen productivity at a reaction temperature lower than the temperatures of conventionally known catalysts such as Ni and Ru. The formation initiation temperature of hydrogen is also as low as 200° C. to 300° C.

### BRIEF DESCRIPTION OF THE DRAWINGS

FIG. 1 is a graph illustrating reaction temperature dependency of the amount of generated hydrogen (%); and

FIG. 2 is an electron microscope photograph illustrating states just after preparation and at a temperature of 450° C. for the Pt/SWNH (Example 1) catalyst.

### BEST MODE FOR CARRYING OUT THE INVENTION

A microporous carbon material is used in a catalyst for methane steam reformation of the present invention and this carbon material may be any of various materials and, more desirably, is suitably considered to be a nanocarbon material having a nanoscale size of 500 nm or less. For example, typical suitable examples include fullerenes such as C60 and C70 and fibers thereof or tubes, single- or multi-layer carbon nanotubes and carbon nanohorns or assembly thereof and modified materials thereof. Herein, the modified materials include, for example, a material the carbon backbone of which has an opening, a material in which the opening is closed, and so forth. The microporous carbon materials may be activated carbon, graphite, and the like. The microporous carbon material having a nanoscale size as described above is suitably considered. Herein, “microporosity” means having a fine pore and the pore is suitably considered to generally have an inner diameter of 100 nm or less, further suitably several tens nm or less.

In a catalyst of the present invention, one kind or more of the microporous carbon materials can be used. This microporous carbon material supports therein one kind or more of noble metals, or one kind or more of each of noble metals and lanthanide metals together.

Example noble metals include Pt, Rh, Pd, Ru, Ir, In, Au, Ag, and the like. Of these, noble metals that are suitably considered include Pt (platinum), Pd (palladium), Ru (ruthenium) and Rh (rhodium). A variety of lanthanide metals may be acceptable. Example suitable lanthanide metals include, for example, Sm (samarium), Eu (europium), Gd (gadolinium), Nd (neodymium), Yb (ytterbium) and, as similar kinds, Y (yttrium) and Sc (scandium).

Lanthanide metals do not exhibit high catalyst activity singly, but explicitly indicate catalyst activity when together with a noble metal.

Furthermore, albeit not essentially, if necessary for stability and the like, one kind or more of alkali metal, alkali earth metals, transition metals, and the like may be added thereto.

When a nanocarbon material is used, carbon nanotubes (NT), carbon nanohorns (NH), and the like, produced or prepared by a variety of means including known methods such as methods established by the present inventors so far, can be employed. This applies also to the modified materials mentioned above.

The amount of a supported noble metal or lanthanide metal based on the microporous carbon material is not particularly limited, and in the case of a noble metal, the supported amount is suitably considered to be from 0.01 to 0.1 by weight, and in the case of lanthanide metals the supported amount is suitably considered to range from 0.001 to 0.1.

A catalyst of the present invention can be produced by a variety of methods including known means for catalyst preparation. For example, the catalyst can be produced by a method of evaporation-drying. This method entails mixing a solvent solution of a compound of a noble metal or lanthanide, e.g., an inorganic acid salt, organic acid salt, complex compound or the like, with a microporous carbon material, and then evaporation-drying. Alternatively, a method of adsorption-supporting is also acceptable. For example, the catalyst can be prepared by a method of mixing and stirring a metal compound with a solvent solution of a microporous carbon material, and adsorption-supporting the metal component, and then filtrating.

A variety of solvents may be acceptable so long as it dissolves a compound of a metal, and a volatile solvent such as alcohol or a low boiling-point solvent is preferably used.

In the preparation of the catalyst of the present invention as described above, the following means may be considered for the purpose of controlling the position and particle diameter of supported noble metals or lanthanide metals.

[symbol] 1 [symbol] A microporous carbon material or a microporous carbon material subjected to oxidation treatment, reduction treatment or oxidation/reduction treatment in advance is contacted with a solution containing a metal component to support the metal while controlling the position.

[symbol] 2 [symbol] A microporous carbon material is subjected to oxidation treatment, reduction treatment or oxidation/reduction treatment in advance and then is contacted with a solution containing a metal component to support the metal while controlling the position.
[symbol] 3 [symbol] The oxidation treatment is a treatment by heating at 200° C. to 1200° C. by use of one kind or more of oxygen, steam, carbon dioxide and the like or a treatment with an oxidant.

[symbol] 4 [symbol] The oxidation treatment is a heating treatment in an air flow of an oxygen concentration of 1% or more in the temperature range of 200° C. to 600° C.

[symbol] 5 [symbol] The oxidation treatment is a liquid phase oxidation treatment using any of hydrogen peroxide, and inorganic acids such as nitric acid and hydrochloric acid or a mixture thereof.

[symbol] 6 [symbol] The reduction treatment is a heating treatment at 200° C. to 1200° C. by hydrogen or a reducing agent.

[symbol] 7 [symbol] The reduction treatment is a heating treatment in an air flow of a hydrogen concentration of 0.1% or more in the temperature range of 300° C. to 1000° C.

[symbol] 8 [symbol] The oxidation/reduction treatment is a reduction treatment following oxidation treatment or an oxidation treatment following reduction treatment.

[symbol] 9 [symbol] The solution containing a metal component is an aqueous solution or alcoholic solution.

[symbol] 10 [symbol] The metal component solution is a solution of any of metal salts or complex salts or a mixture thereof.

[symbol] 11 [symbol] The metal component solution is a noble metal component solution in which a noble metal is supported in a carbon material.

[symbol] 12 [symbol] The solution containing a metal component is an aqueous solution of at least one kind of the complex salts of Pt, Pd, Rh, Ru, Ir, Au, Ag and lanthanide metals or ethanol solution.

[symbol] 13 [symbol] The solution containing a metal component is an aqueous solution of any of platinum ammine, bisethanol ammonium platinum and dinitrodiamine platinum or ethanol solution.

[symbol] 14 [symbol] The control of a supported position by contact with the solution containing a metal component is carried out by changing the hydrogen ion concentration of the solution.

[symbol] 15 [symbol] The microporous carbon material is mixed with the solution containing a metal component and further subjected to ultrasonic treatment and then evaporation-dried.

[symbol] 16 [symbol] The position of a supported metal is at least any of a wall face, outer edge and inner edge of a carbon nanohorn or carbon nanotube or in a space created between the particles.

[symbol] 17 [symbol] The average particle diameter of a metal to be supported is in the range of 0.5 nm to 5 nm.

In addition, it is effective that a catalyst of the present invention is evaporation-dried or adsorption-supported, and then pre-treated with hydrogen prior to methane steam reformation reaction. This catalyst treatment with hydrogen is considered to be carried out normally at a temperature from 200° C. to 350° C. for 10 minutes to several hours. This treatment is particularly effective as treatment prior to reaction, for example, for a catalyst or the like prepared by use of a nitrate salt of a metal.

In the production of hydrogen by a methane steam reformation method using a catalyst of the present invention, a variety of techniques of the reaction processes may be acceptable, and for example a reaction technique of fixed bed gas circulation is adopted.

The ratio of methane to steam in the reaction is generally considered to be one or more, more preferably two or more. A catalyst of the present invention has characteristics that it has catalyst activity in the reaction temperature range of 100° C. to 800° C. in general and in particular that it exhibits high activity at a low reaction temperature as compared with the conventional temperature, i.e., lower than 700° C. From this standpoint, the reaction temperature can be, as a measure, normally in the range of 200° C. or higher to 700° C. or lower and further in the range of 300 to 600° C. In either case, methane steam reformation reaction by a high catalyst activity is possible at a further low reaction temperature as compared with a temperature of 700 to 800° C., which is regarded desirable in the conventional method.

In addition, a catalyst of the present invention is rarely expected to improve the production efficiency of hydrogen at a temperature of 800° C. or higher. Moreover, a catalyst of the present invention has a characteristic of initiating hydrogen formation in the temperature range as low as 200 to 300° C.

Additionally, in the reaction temperature range of 300 to 600° C., the amount of generated hydrogen is expected to exceed a level of 5%.

The amount of generated hydrogen is defined as follows.

In other words, the amount of generated hydrogen=MH/(MH+MM+MC1+MC2)×100(%), where MH is the hydrogen concentration of the outlet gas, MM is the methane concentration, MC2 is the CO₂ concentration and MC1 is the CO concentration.

SV for reaction (gas flow rate per volume) is the SV of hydrogen, assuming that the charged methane is all converted into hydrogen, i.e., the theoretical value of hydrogen SV is considered to be generally 3000 hr⁻¹ or less.

Now, the invention will be set forth in detail by way of example hereinafter. The following examples by no means limit the invention.

### EXAMPLES

The following catalysts were prepared by an evaporation-drying method using a solution of a metal compound and SWNH (single layer carbon nanohorn).
Example 1: Pt/SWNH (Pt 4 wt % supported)
Example 2: Ru/SWNH(Ru 2 wt % supported)
Example 3: Eu.Pt/SWNH (Pt 4 wt %, Eu 0.1 mmol/SWNH 1 g supported)
In preparation, for example, in the case of Example 1, a Pt ammine (IV) solution (8 mg in terms of the amount of Pt) was added to 96 mg of SWNH and stirred for one hour, and then the resulting solution was filtrated and washed with three times with 10 mL of purified water. Thereafter, the sample remaining on the filter was dried in a nitrogen flow (room temperature) to obtain a Pt/SWNH catalyst.

Example 2 was carried out similarly.

In addition, for Example 3, to 99 mg of Pt/SWNH obtained by the above method was added a nitric acid Eu solution (1 mg in terms of Eu) and well stirred, and then the resulting solution was evaporation-dried in a nitrogen flow (room temperature). The resulting sample was subjected to hydrogen flow treatment at 300° C. for one hour to remove silver nitrate.

Moreover, as the SWNH, a material produced by laser application using a graphite target in an Ar atmosphere was used.

In addition, for comparison, the following materials were prepared by a similar evaporation-drying method.
Comparative Example 1: SWNH
Comparative Example 2: Eu/SWNH (Eu 0.1 mmol/SWNH 1 g supported)
Comparative Example 3: Ni/Al₂O₃ (Ni 4 wt % supported)
Comparative Example 4: Ru/Al₂O₃ (Ru 4 wt % supported)
Methane steam reformation reaction was carried out using the catalysts under conditions of the theoretical hydrogen SV=1250 hr⁻¹ and the ratio of methane to steam of 3.5. A micro gas chromatograph available from Agilent Technologies was used as a measurement apparatus.

Table 1 shows the amount of generated hydrogen (%) at reaction temperatures of 350° C. and 450° C. (temperature within the reaction tube).

TABLE 1
Generated hydrogen amount (%)

| Test No. | 350° C. | 450° C. |
|---|---|---|
| Example 1 | 27 | 30 |
| Example 2 | 25 | 28 |
| Example 3 | 35 | 37 |
| Comparative example 1 | <1 | <1 |
| Comparative example 2 | <1 | 2 |
| Comparative example 3 | 3 | 5 |
| Comparative example 4 | 4 | 5 |

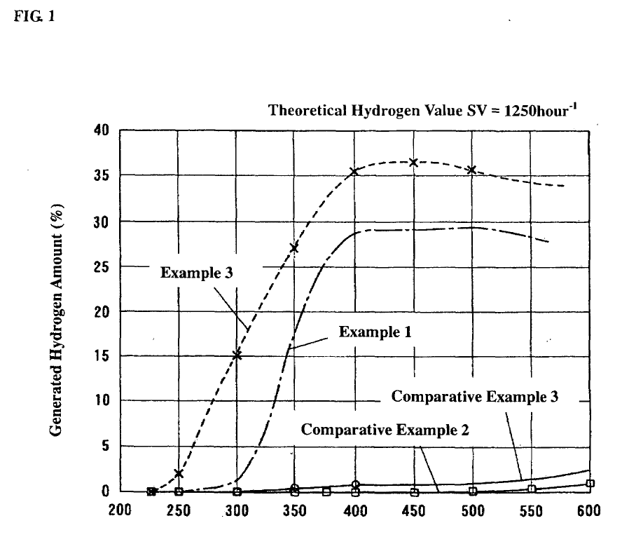

In addition, FIG. 1 shows the reaction temperature dependency of the catalysts of Examples 1 and 3 and the amounts of generated hydrogen (%) of Comparative Examples 2 and 3. The furnace temperature (° C.) is shown in the graph and the bed temperature, or the temperature within the reaction tube, is the furnace temperature minus 40° C.

The results show that the catalysts of Examples 1 to 3 have excellent catalyst activities of hydrogen formation at a further low temperature as compared with the conventional reaction temperature.

Table 2 shows temperatures at which hydrogen formation is initiated. The examples of the present invention show that hydrogen generation is initiated at temperatures from 250 to 300° C.

TABLE 2

| | Hydrogen generation |
|---|---|
| Test No. | initiation temperature (° C.) |
| Example 1 | 300 |
| Example 2 | 290 |
| Example 3 | 250 |
| Comparative example 3 | 520 |
| Comparative example 4 | 480 |

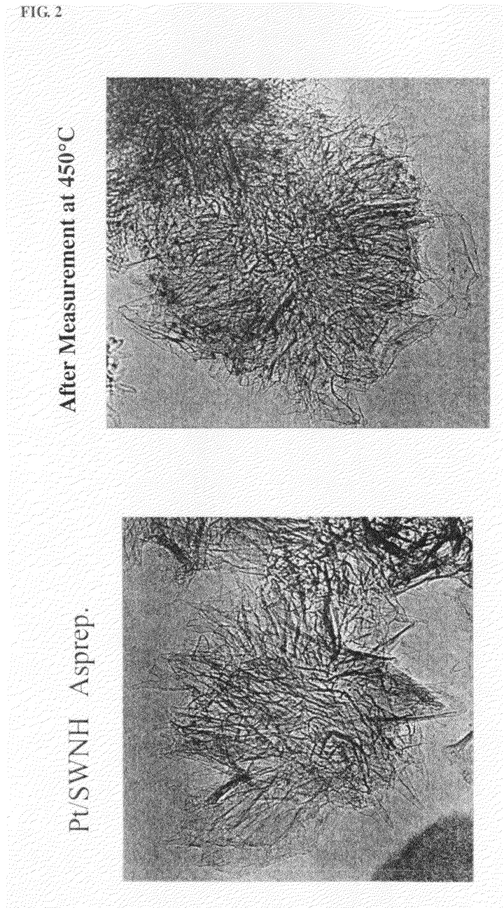

Furthermore, the states of the catalyst of Example 1 above were observed just after preparation and at a temperature of 450° C. As shown in FIG. 2, substantially no large changes were observed.

Change in the amount of nitrogen adsorption due to the temperature is also evaluated, and it was confirmed that substantially no changes were observed between 300° C. and 450° C.

1-7. (canceled)

8. A catalyst for methane steam reformation, wherein one kind or more of noble metals or one kind or more of each of noble metals and lanthanide metals are supported in a microporous carbon material, the microporous carbon material being at least either of a carbon nanotube and a carbon nanohorn.

9. A method of producing the catalyst for methane steam reformation of claim 8, comprising mixing a solution of a compound of a noble metal or of a noble metal and a lanthanide metal and a microporous carbon material of at least either of a carbon nanotube and a carbon nanohorn, and then evaporation-drying or adsorption-supporting.

10. The method of producing the catalyst for methane steam reformation of claim 9, comprising subjecting a microporous carbon material to oxidation treatment or hydrogen treatment in advance and then mixing the resulting microporous carbon material with a solution of a compound of a metal.

11. A method of producing a catalyst for methane steam reformation, comprising water-contact treating at a temperature of 200° C. to 350° C. after evaporation-drying or adsorption-supporting in the method of claim 9.

12. A method of producing a catalyst for methane steam reformation, comprising water-contact treating at a temperature of 200° C. to 350° C. after evaporation-drying or adsorption-supporting in the method of claim 10.

13. A method of producing hydrogen by steam reformation reaction of methane, comprising producing hydrogen by use of the catalyst of claim 8 by steam reformation reaction of methane.

14. The method of producing hydrogen by steam reformation reaction of methane of claim 13, comprising carrying out steam reformation reaction at a reaction temperature of 300° C. to 600° C.
